(19) United States
(12) Patent Application Publication
(10) Pub. No.: US 2025/0240232 A1
(43) Pub. Date: Jul. 24, 2025

(54) MEDIA DATA TRANSMISSION LINK OPTIMIZATION METHOD, APPARATUS, DEVICE, AND STORAGE MEDIUM

(71) Applicant: Beijing Zitiao Network Technology Co., Ltd., Beijing (CN)

(72) Inventor: Xiao GU, Beijing (CN)

(21) Appl. No.: 18/955,148

(22) Filed: Nov. 21, 2024

(30) Foreign Application Priority Data
Jan. 23, 2024 (CN) 202410094834.7

(51) Int. Cl. H04L 45/12; H04L 43/0864; H04L 43/10

(52) U.S. Cl. CPC H04L 45/124; H04L 43/0864; H04L 43/10

(57) ABSTRACT

The present disclosure relates to the technical field of media data transmission, and discloses a media data transmission link optimization method, an apparatus, a device, and a storage medium. The media data transmission link optimization method comprises: sending a report message to a second edge node that is a next hop node successfully connected with a first edge node; determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node; optimizing a media data transmission link including the first edge node according to the message loss result and the round-trip time result.

### CROSS-REFERENCE TO RELATED APPLICATION(S)

This application claims priority to Chinese Application No. 202410094834.7 filed in Jan. 23, 2024, the disclosures of which are incorporated herein by reference in their entities.

### FIELD

The present disclosure generally relates to the technical field of media data transmission, and more specifically, to a media data transmission link optimization method, an apparatus, a device, and a storage medium.

### SUMMARY

In view of the above, the present disclosure provides a media data transmission link optimization method, an apparatus, a device, and a storage medium to solve the problems of untimely network failure awareness and untimely transmission link optimization in the related art.

In a first aspect of the present disclosure, there is provided a media data transmission link optimization method. The method is applied to a first edge node. The method comprises:
sending a report message to a second edge node that is a next hop node successfully connected with the first edge node;
determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node;
optimizing a media data transmission link including the first edge node according to the message loss result and the round-trip time result.

Based on the report message sent by the first edge node to the next hop node and the acknowledgement message fed back by the next hop node in response to the report message, the present disclosure realizes a detection function of each hop cascading link, and specifically uses a statistical message loss result and a round-trip time result to sense in time whether a media data transmission network fails and to optimize in time upon transmission link failure. It can be seen that the present disclosure effectively solve the problems of untimely network failure awareness and untimely transmission link optimization in the related art, and the present disclosure helps to improve the communication quality of a media data transmission network and to enhance the user's audiovisual experience.

In a second aspect of the present disclosure, there is provided a media data transmission link optimization apparatus. The apparatus comprises:
a message sending module used for sending a report message to a second edge node, wherein the second edge node is a next hop node successfully establishing a connection with a first edge node;
a result determination module used for determining a message loss result and a round-trip time result according to an acknowledgement message replied by the second edge node based on the report message, wherein the message loss result is used for characterizing a situation that the report message is lost, and the round-trip time result is used for characterizing transmission delay between the first edge node and the second edge node;
a link optimization module used for optimizing a media data transmission link including the first edge node according to the message loss result and the round-trip time result.

In a third aspect of the present disclosure, there is provided a computer device comprising: a memory and a processor communicatively coupled to each other, the memory having computer instructions stored therein, the processor executing the computer instructions to perform the media data transmission link optimization method of the above first aspect or any embodiment corresponding thereof.

In a fourth aspect of the present disclosure, there is provided computer-readable storage medium having stored thereon computer instructions for causing a computer to perform the media data transmission link optimization method of the above first aspect or any embodiment corresponding thereof.

### BRIEF DESCRIPTION OF THE DRAWINGS

In order to more clearly illustrate the technical solution of the specific embodiments in the present disclosure or in the prior art, a brief introduction will be made to the drawings which are required to be used in the specific embodiments or the depiction of the prior art. It would be obvious that the drawings in the following depiction refer to some embodiments of the present disclosure, and other drawings can be obtained from the drawings herein by a person skilled in the art without involving any inventive effort.

FIG. 1 illustrates a flow diagram of a media data transmission link optimization method in accordance with an embodiment of the present disclosure;

FIG. 2 illustrates a flow diagram of another media data transmission link optimization method in accordance with an embodiment of the present disclosure;

FIG. 3 illustrates a schematic diagram of the operational principle of cascade link detection in accordance with an embodiment of the present disclosure;

FIG. 4 illustrates a flow diagram of yet another media data transmission link optimization method in accordance with an embodiment of the present disclosure;

FIG. 5 illustrates a schematic diagram of the operational principle of a cascading retry strategy in accordance with an embodiment of the present disclosure;

FIG. 6 illustrates a schematic diagram of the operational principle of another cascade link detection in accordance with an embodiment of the present disclosure;

FIG. 7 illustrates a flow diagram of yet another media data transmission link optimization method in accordance with an embodiment of the present disclosure;

FIG. 8 illustrates a schematic diagram of the operational principle of a loopback detection scheme in accordance with an embodiment of the present disclosure;

FIG. 9 illustrates a schematic flow diagram of a loopback detection method in accordance with an embodiment of the present disclosure;

FIG. 10 illustrates a flow diagram of a method for fast obstacle avoidance for a media data transmission link in accordance with an embodiment of the present disclosure;

FIG. 11 illustrates a block diagram of a media data transmission link optimization apparatus in accordance with an embodiment of the present disclosure;

FIG. 12 illustrates a schematic diagram of a computer device according to an embodiment of the present disclosure.

### DETAILED DESCRIPTION OF EMBODIMENTS

In order to make the purpose, technical scheme and advantages of the embodiment of the disclosure more clear, the technical scheme in the embodiment of the disclosure will be described clearly and completely in view of the attached drawings. Obviously, the described embodiment is a part of the embodiment of the disclosure, but not the whole embodiment. Based on the embodiments in the present disclosure, all other embodiments obtained by those skilled in the art without creative work belong to the protection scope of the present disclosure.

Currently, the common media data network transmission in industries relies on the transmission network SDN (Software Defined Network) of RTN (Real Time Network). In this way, the SDN controller collects real-time status information of each transmission link in the network and selects the best transmission link for transmitting media data according to a certain strategy to realize link optimization upon transmission link failure. For example, providing about 1.5 minutes (min) of network automatic recovery after a transmission link failure, it can be seen that since the entire link optimization process of the existing scheme needs to rely on a SDN controller, it is prone to problems of untimely network failure awareness and untimely transmission link optimization.

In the related art, a scheme for relying on an SDN controller to optimize a media data transmission link can be achieved by means of route switching of a transmission layer, etc. In this way, a recovery time of up to 1.5 minutes would significantly affect the user's audiovisual experience, namely, there is a problem of a long time for automatic network recovery, and this is easy to lead to customer churn. Furthermore, the related art cannot solve the link loopback problem: taking a source station S, an edge node A and an edge node B as an example, assuming that a push flow end is at the source station S, and two pull flow ends are respectively arranged at the edge node A and the edge node B; when A and B obtain a pull flow link from a scheduling service at the same time, the path issued to the edge node A after scheduling is A→B→S and the path issued to the edge node B is B→A→S; at this moment, a problem of ring A→B→A or ring B→A→B may be resulted. That is to say, there is a problem that neither A nor B can reach the source station, resulting in a problem that a user cannot hear audio and cannot see video. Moreover, the link optimization method based on SDN controller can not recover the link automatically when a link loopback problem occurs.

In accordance with embodiments of the present disclosure, there is provided an embodiment of a media data transmission link optimization method. It should be noted that the steps illustrated in the flowchart of the drawings may be performed in a computer system, such as a set of computer-executable instructions, and that, although a logical order is illustrated in the flowchart, in some cases, the steps illustrated or described may be performed in an order different than here.

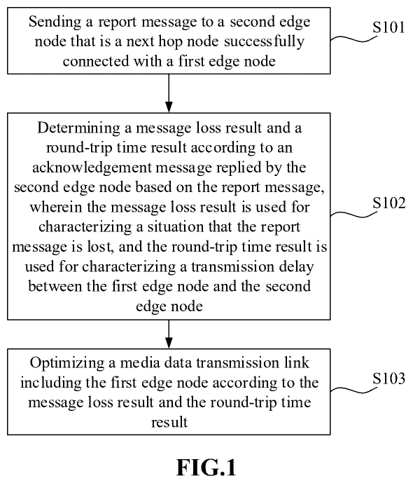

In the present disclosure, a media data transmission link optimization method is provided and can be used for a first edge node. FIG. 1 illustrates a flow diagram of a media data transmission link optimization method in accordance with an embodiment of the present disclosure. As shown in FIG. 1, the flow chart comprises the following steps:

Step S101, sending a report message to a second edge node that is a next hop node successfully connected with the first edge node.

In this embodiment, the first edge node is any edge node in the media data transmission network and the second edge node is the next hop node in the communication direction from the first edge node to the source station.

The report message is a message type sent by the first edge node to the next hop node, and contains report information about a certain event or situation by the first edge node.

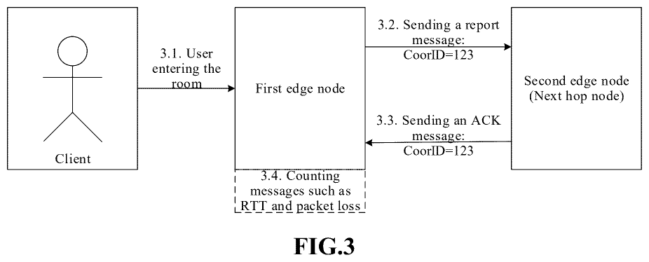

As shown in FIG. 3, the first edge node and the second edge node are two edge nodes of the service end. Taking a video conference or a live broadcast scenario as an example, under the condition that after a user enters a current room in the video conference or the live broadcast scenario (namely, 3.1. Users entering the room), and a first edge node successfully establishes a connection with a cascaded next hop node, the first edge node in the present embodiment sends a report (Report) message to the next hop node every first specified duration through a preset channel (namely, 3.2. Sending a report message; coorID=123), wherein the preset channel may specifically be a data channel, and the first specified duration may be, for example, 3 seconds. The Report message in the present embodiment carries a CoorID (a unique identifier) used for identification of the report message by the next hop node, and the CoorID=123.

Step S102, determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node.

In conjunction with FIG. 3, the second edge node responds to the report message, and specifically feeds back an acknowledgement message to the first edge node (namely, 3.3. Sending an ACK message; coorID=123). The acknowledgement message is specifically an ACK (Acknowledgement) message, and the ACK message carries the original CoorID (unique identifier) in the report message. Then, the first edge node may determine a message loss result and a round-trip time result (i.e. 3.4. Counting messages such as RTT and packet loss) according to a series of sent report messages and a series of received acknowledgement messages, wherein the round-trip time result may comprise RTT (Round Trip Time) information, etc. and the message loss result may comprise packet loss information, etc.

In some alternative embodiments, the message loss result comprises a number of message loss and the round-trip time result comprises an average round-trip time.

Specifically, the above-mentioned step S202 includes:

Step a1, counting a total number of acknowledgement messages replied by the second edge node based on a specified number of report messages, and determining a plurality of round-trip times based on the specified number of report messages.

In some specific embodiments, the specified amount may be, for example, 20.

The first edge node of the present embodiment aggregates responses of the specified number of report messages in the past every second specified duration, i.e. receives an acknowledgement message that the second edge node replies with respect to the specified number of report messages, and the second specified duration may be, for example, 3 seconds.

In step a2, determining a difference value between the specified number and the total number of acknowledgement messages as the number of message loss (Loss), and the average of a plurality of round-trip times is determined as the average round-trip time (AverageRTT).

Specifically, the round-trip time is a difference value between the time when the first edge node receives the acknowledgement message and the time when the corresponding report message is sent. In the case where the ACK message is not received after the third specified duration is timed out, the loss of the ACK message corresponding to the current report message is recorded, and in the case where the loss of the ACK message is judged, the third specified duration can be taken as the round-trip time in the present embodiment. In some embodiments, the third specified duration is, for example, 5 seconds.

If taking 20 report messages as an example, the number of message loss is a difference value between 20 and the number of received acknowledgement messages (e.g. 18) (e.g. 20-18=2), and the average round-trip time is an average of the 20 round-trip times determined based on the 20 report messages.

The present embodiment can accurately judge the communication link condition between the first edge node and the second edge node through the statistics and calculation of a specified number of report messages and acknowledgement messages to realize high-precision detection of the cascade link.

Step S103, optimizing a media data transmission link including the first edge node according to the message loss result and the round-trip time result.

Media data related in the present disclosure may include, but is not limited to, one or more of video data, audio data, data channel messages.

Specifically, if the result of message loss is too large and/or the result of round-trip time is too large, it can be identified that the communication link between the first edge node and the second edge node is poor, and the path can be avoided when the communication path is subsequently planned; and in the case where the communication between the first edge node and the second edge node is too bad, the connection between the first edge node and the second edge node is disconnected; if the number of message loss results is small and the round-trip time result value is small, the connection between the first edge node and the second edge node is maintained.

The media data transmission link optimization method provided in the present embodiment realizes the detection function of each hop cascade link based on the report message sent by the first edge node to the next hop node and the acknowledgement message fed back by the next hop node in response to the report message, and uses the statistical message loss result and the round-trip time result to timely sense whether the media data transmission network fails and timely perform optimization upon the transmission link failure. It can be seen that the present embodiment, compared with the method for performing media data transmission link optimization based on the SDN controller, effectively solves the problems of the related art that network failure perception is not timely and transmission link optimization is not timely, and the network recovery time after a link failure can be shortened from 1.5 minutes to 3 seconds to 30 seconds, and the embodiments of the present disclosure help to improve the communication quality of a media data transmission network and improve the user's audiovisual experience.

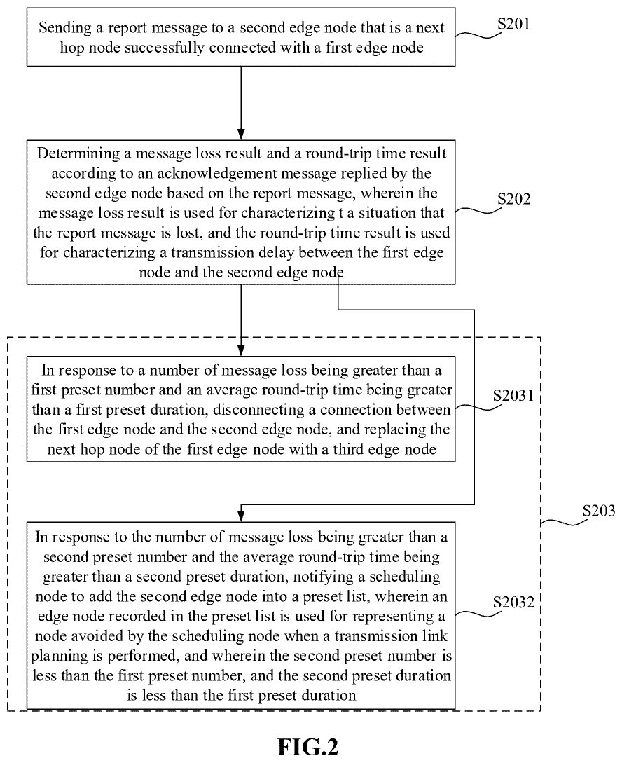

In the present embodiment, a media data transmission link optimization method is provided and can be used for a first edge node. FIG. 2 illustrates a flow diagram of another media data transmission link optimization method in accordance with an embodiment of the present disclosure. As shown in FIG. 2, the flow chart comprises the following steps:

Step S201, sending a report message to a second edge node, wherein the second edge node is a next hop node successfully establishing a connection with a first edge node. Reference is made in detail to step S101 of the embodiment shown in FIG. 1, and the description thereof would not be repeated here.

Step S202, determining a message loss result and a round-trip time result according to an acknowledgement message replied by the second edge node based on the report message, wherein the message loss result is used for characterizing a situation that the report message is lost, and the round-trip time result is used for characterizing transmission delay between the first edge node and the second edge node. Reference is made in detail to step S102 of the embodiment shown in FIG. 1, which would not be described again here.

Step S203, optimizing a media data transmission link including the first edge node according to the message loss result and the round-trip time result.

Specifically, the above-mentioned step S203 includes step S2031 and/or step S2032.

Step S2031, if the number of message loss being greater than the first preset number and the average round-trip time being greater than the first preset duration, disconnecting the connection between the first edge node and the second edge node, and replacing the next hop node of the first edge node with a third edge node.

The first preset number and the first preset duration in the present embodiment are both configurable, the first preset number being, for example, 5, and the first preset duration being, for example, 3 seconds.

In particular, in the case of Loss>5 and Average RTT>3 seconds, the connection between the first edge node and the second edge node is disconnected, and the link is changed to retry a connection with a next hop.

In the present embodiment, in the case where the number of message loss is too large and the average round-trip time is too large, the next hop node of the first edge node can be replaced from the second edge node to the third edge node, thereby ensuring that the first edge node is reliably provided with media data, optimizing the media data transmission link and improving the audiovisual experience of the client.

In addition, in the case where it is found that the communication quality of a media data transmission link is poor, the present embodiment can perform link automatic recovery by means of link retry. This embodiment can help solve the link loopback problem based on an automatic retry approach.

Step S2032, if the number of message loss being greater than the second preset number and the average round-trip time being greater than the second preset duration, notifying the scheduling node to add the second edge node into the preset list; an edge node recorded in a preset list being used for representing a node avoided by a scheduling node when transmission link planning is performed; wherein the second preset number is less than the first preset number, and the second preset duration is less than the first preset duration.

The second preset number and the second preset duration in the present embodiment are both configurable, wherein the second preset number is, for example, 2, and the second preset duration is, for example, two seconds.

In particular, in the case where Loss>2 and AverageRTT>2 seconds, the scheduling node may be notified to add the second edge node into the preset list, and negative feedback is specifically sent to the scheduling service so that the scheduling service is aware that the link communication quality is poor, and this factor may be considered when subsequently a path is planned, for example, avoiding the first edge node.

The media data transmission link optimization method provided in the present embodiment can also identify a poor communication quality between the first edge node and the second edge node, and can use the poor communication quality as a basis for subsequent link planning to improve the rationality of link planning and achieve the purpose of quickly avoiding obstacles.

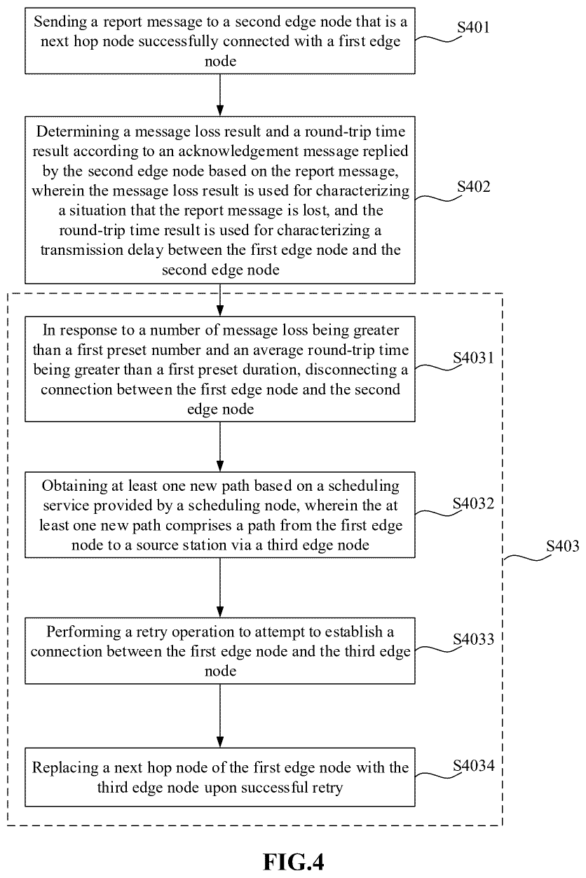

In the present embodiment, a media data transmission link optimization method is provided and can be used for the first edge node. FIG. 4 illustrates a flow diagram of yet another media data transmission link optimization method in accordance with an embodiment of the present disclosure. As shown in FIG. 4, the flow chart comprises the following steps:

Step S401, sending a report message to a second edge node that is a next hop node successfully connected with the first edge node. Reference is made in detail to step S201 of the embodiment shown in FIG. 2, which would not be described again.

Step S402, determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node. Reference is made in detail to step S202 of the embodiment shown in FIG. 2, which would not be described again.

Step S403, optimizing a media data transmission link including the first edge node according to the message loss result and the round-trip time result.

Specifically, the above step S403 includes:

Step S4031, if the number of message loss being greater than the first preset number and the average round-trip time being greater than the first preset duration, disconnecting the connection between the first edge node and the second edge node. Referring to step S2031 of the embodiment shown in FIG. 2, on this basis, the present embodiment further comprises steps S4032 and S4033.

Step S4032, obtaining at least one new path based on a scheduling service provided by a scheduling node, wherein the at least one new path comprises a path from a first edge node to a source station via a third edge node.

The scheduling node is a node independent from the edge node in the service end and is used for providing a scheduling service, and the scheduling service can be used for providing a new path from the first edge node to the source station for the first edge node, and the first edge node performs cascade retry according to the new path provided by the scheduling service so as to try to connect with the new node.

Step S4033, performing a retry operation to attempt to establish a connection between the first edge node and the third edge node.

The third edge node is a node in the above-mentioned at least one new path, and in the process of the first edge node trying, the retry may succeeds or fails. Upon successful retry, the first edge node establishes a connection with a new node, for example, establishing a connection with the third edge node.

Step S4034, replacing the next hop node of the first edge node with the third edge node upon successful retry.

As shown in FIG. 5, a schematic diagram of the operational principle of the cascading retry strategy of the present embodiment is provided. The connection between a first edge node E and a second edge node R1 therein may be disconnected (for example, 5.1. Network jitter and an abnormal disconnection of a cascade connection in FIG. 5), and then the first edge node E needs to re-plan a connection with a new edge node (5.2. Re-planning a path), specifically obtaining the new path from a scheduling node Q, and connecting from the new node determined in the new path (5.3. Establishing a connection), namely, performing a retry operation, for example, establishing a connection with a third edge node R2; if the establishment of the connection is successful (namely, the retry is successful), the third edge node R2, which has been successfully established with the source station S, serves as a current upstream node of the first edge node E.

It can be seen that the present embodiment adopts a smoothing strategy when replacing a link between cascaded links, namely, providing a strategy which only requires a retry of an internal edge node of a service end, rather than a retry of a client, achieving the purpose of the client having no perception of link replacement, etc., and the effect of the client having no perception of link switching, and improving the user's audiovisual experience.

Specifically, the above-mentioned step S403 further includes:

Step S4035, upon failed retry, performing a retry again to try to establish a connection between the first edge node and the fourth edge node.

The fourth edge node of the present embodiment is a new node different from the third edge node, and in case the connection with the third edge node fails (retry failure), the first edge node may attempt to establish a connection with the fourth edge node in yet another new path provided by the scheduling service.

Step S4036, if the number of times of consecutive failed retry exceeds the first preset number, moving out the client from the first edge node (Node Change), and the edge node providing the media data service for the client is switched from the first edge node to the fifth edge node.

The first preset number of times is configurable, for example, the first preset number of times is three times. In the case where the number of times of retry of consecutive failure exceeds the first preset number, the present embodiment may determine the first edge node as a network islanding, and move out users in the first edge node, and switch the moved users to the fifth edge node.

The number of times of retry of consecutive failure in the present embodiment is the number of times

of retry connection failure with a plurality of edge nodes, and the first preset number of times may specifically be the number of edge nodes of multiple retry connections.

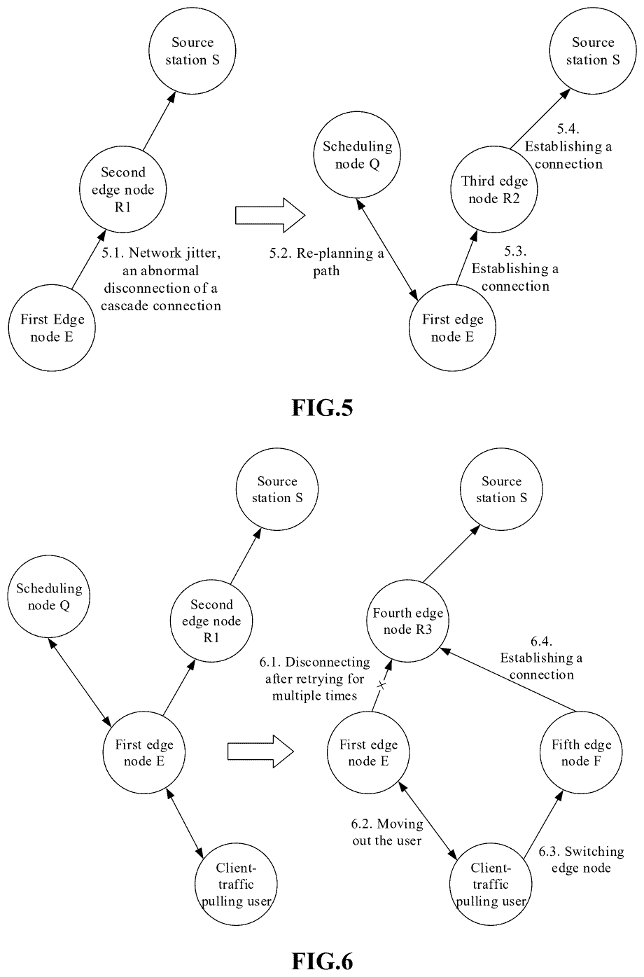

As shown in FIG. 6, a schematic diagram of the operational principle of another cascade link detection of the present embodiment is provided.

In an initial state, the first edge node E can establish a connection with the second edge node R1 based on a scheduling service provided by the scheduling node Q, and the second edge node R1 is connected to the source station S, and the first edge node E provides a traffic pulling service for a client so as to provide audio and video data for a traffic pulling user; after the first edge node E is caused to disconnect from the second edge node R1 in the case of network jitter, etc. the first edge node E establishes a connection with a new node based on a new path provided by the scheduling service, for example, establishing a connection with the a new node such as the fourth edge node R3, and if the connection retry with multiple edge nodes fails for multiple times (6.1. Disconnecting after retrying for multiple times), the first edge node E moves out the traffic pulling user (6.2. Moving out the user), and the removed client will be transferred to the new node (6.3. Switching edge node), for example, transferring to the fifth edge node F; wherein the fifth edge node F can be connected to the source station S via the fourth edge node R3 (the fifth edge node F has established a connection with the fourth edge node R3, namely, 6.4. Establishing a connection).

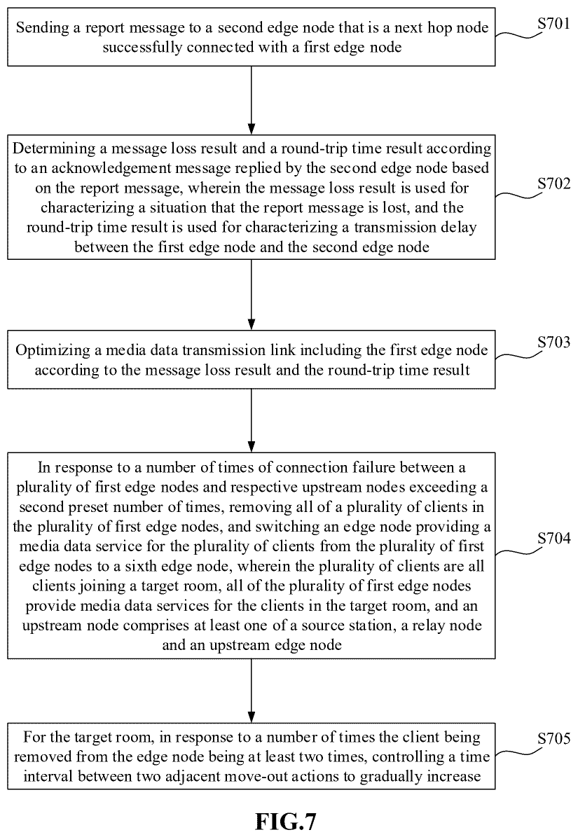

In the present embodiment, a media data transmission link optimization method is provided and can be used for a first edge node. FIG. 7 illustrates a flow diagram of the media data transmission link optimization method in accordance with an embodiment of the present disclosure. As shown in FIG. 7, the flow chart comprises the following steps:

Step S701, sending a report message to a second edge node that is a next hop node successfully connected with the first edge node. Reference is made in detail to step S101 of the embodiment shown in FIG. 1, and the description thereof would not be repeated here.

Step S702, determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node. Reference is made in detail to step S102 of the embodiment shown in FIG. 1, which would not be described again here.

Step S703, optimizing a media data transmission link including the first edge node according to the message loss result and the round-trip time result. Reference is made in detail to step S103 of the embodiment shown in FIG. 1, which would not be described again.

Step S704, if the number of times the connection between the plurality of first edge nodes and the respective upstream nodes failing exceeds a second preset number of times, removing all the plurality of clients in the plurality of first edge nodes, and switching the edge node providing the media data service for the plurality of clients from the plurality of first edge nodes to a sixth edge node; wherein a plurality of clients are all clients joining a target room, a plurality of first edge nodes provide a media data service for the clients in the target room, and an upstream node comprises at least one of a source station, a relay node and an upstream edge node.

The second preset number of times is configurable, and the second preset number of times example, three.

In this embodiment, the respective upstream nodes of the plurality of first edge nodes may be the same node.

In conjunction with the above-mentioned embodiments, concentrated and large Node Change at the edge node may cause an avalanche, for example, if the edge node A1, the edge node A2 and the edge node A3 are all connected to the edge node B1, the edge node B1 would have a network problem; if the edge node A1, the edge node A2 and the edge node A3 fail to be connected to the edge node B1 for multiple times, in the case of moving out all the users in the edge node A1, the edge node A2 and the edge node A3, these nodes flood the edge node A4 in a short time; when the edge node A4 in the present embodiment is connected to the edge node B2, and the edge node A4 is in normal operation; when the edge node A4 is flooded for a short time, the edge node A4 may not be able to bear the number of users of the edge node A1, the edge node A2 and the edge node A3, resulting in the problem that the edge node A4 is unavailable, namely, an avalanche occurs. In some embodiments, the edge node B1 and the edge node B2 may be source stations.

Step S705, for the target room, if the number of times the client being removed from the edge node being at least two times, controlling a time interval between two adjacent move-out actions to gradually increase.

For the same room, i.e. the aforementioned target room, the present embodiment controls that the time interval of two adjacent move-out actions gradually increases, in particular the time interval of the latter is longer than the time interval of the former. For example, for the same room, Node Change follows the following strategy: the second and first Node Change shall be separated by at least 5 seconds; the 3rd and 2nd Node Change shall be separated by at least 7 seconds; there needs to be at least 10 seconds between the 4th time and the previous Node Change. The specific time interval may be configured, and is not limited to the specific values described above.

The present embodiment, by controlling the time interval between two adjacent Node Change, avoids the problem of a large amount of user traffic flooding an edge node in a short period of time to some extent, i.e. the present embodiment can reduce the probability of the avalanche.

In some alternative embodiments, the media data transmission link optimization method further comprises:

Step b1, if heartbeat information sent by the source station is not received within the third preset duration, it is determined that the source station is unreachable.

The heartbeat information is specifically a heartbeat HB (Heart Beat) signal, and the third preset duration is specifically a maximum gap time threshold (HBMaxGapMs), and the specific value of the maximum gap time threshold can be configured, for example, 8 seconds.

For example, the source station where a streaming end is located periodically initiates a heartbeat and broadcasts the same to the downstream node, and the period of the source station broadcasting the heartbeat in the present embodiment is a heartbeat period (HBBroadCastPeriodMs); the specific value of the heartbeat cycle can be configured, for example, 3 seconds.

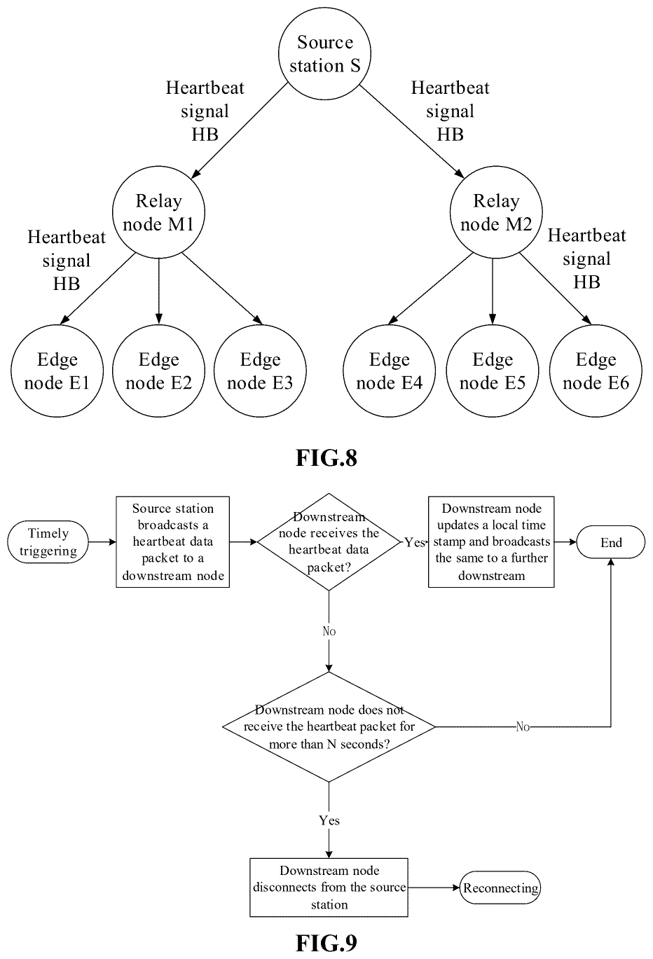

As shown in FIG. 8, a schematic diagram of the operational principle of the loopback detection scheme of this embodiment is provided. The source station S sends the heartbeat signal HB to the relay nodes such as the relay node M1 and the relay node M2 or the edge node every 3 seconds, and then the relay nodes such as the relay node M1 and the relay node M2 or the edge node receiving the heartbeat signal HB continue to broadcast the heartbeat signal HB to the downstream nodes, for example, the relay node M1 broadcasts the heartbeat signal HB to the edge node E1, the edge node E2 and the edge node E3, and the relay node M2 broadcasts the heartbeat signal HB to the edge node E4, the edge node E5 and the edge node E6.

In particular, the heartbeat information may include, but is not limited to, timestamp, raw port information, raw IP (Internet Protocol) information, raw public IP information, etc.

Step b2, if heartbeat information sent by the source station is received within the third preset duration, the heartbeat information is broadcast to the downstream node, wherein the downstream node comprises at least one of the downstream edge node and the relay node.

In this embodiment, the first edge node maintains the heartbeat information, and periodically detects whether the heartbeat information sent by the source station is received. Specifically, the first edge node updates a local time stamp after receiving the heartbeat information, and broadcasts the current heartbeat to the downstream node (specifically, the downstream media node in the present embodiment).

The present embodiment provides a loopback detection method based on link keep-alive so as to detect a stable link connection between the first edge node and the source station to ensure the reliability of media data link communication.

In some alternative embodiments, the media data transmission link optimization method further comprises:

Step c1, if it is determined that the source station is not reachable, the connection between the first edge node and the second edge node is disconnected, and a timed retry is performed after a fourth preset duration so as to try to establish a connection between the first edge node and the source station.

The specific value of the fourth preset duration can be configured, and the fourth preset duration can be, for example, 3 seconds. It can be seen that the present embodiment is able to retry every 3 seconds if the source station is not reachable, and the node of the retry connection may be another upstream node than the second edge node, so that the first edge node attempts to establish a connection with the source station.

Based on the loopback detection method described above, the present embodiment can not only perceive the link loopback in time, but also automatically recover and effectively solve the problem that the user cannot hear the audio and/or see the video for a long time due to the link loopback.

As shown in FIG. 9, a flow chart of the loopback detection method of the present embodiment is provided.

In conjunction with the above-mentioned embodiments, the source station periodically (according to the heartbeat period) triggers an issuing action of the heartbeat information, and specifically, the source station broadcasts a heartbeat data packet to the downstream node, and if the downstream node receives the heartbeat data packet, the downstream node updates the local time stamp and broadcasts same to a further downstream node, and then ends; if the downstream node does not receive the heartbeat packet and does not receive the heartbeat packet for more than N seconds (e.g. 8 seconds), the downstream node disconnects from the source station and then performs the timed retry to reconnect with the source station.

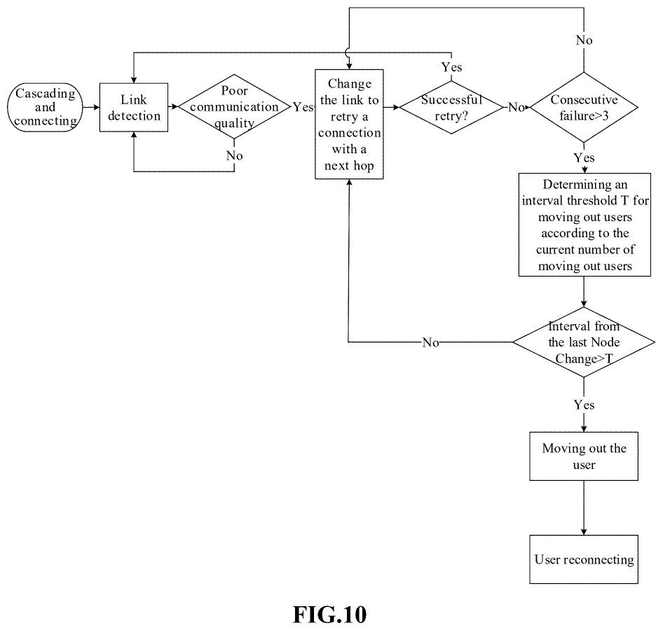

As shown in FIG. 10, a flow chart diagram of a method for fast obstacle avoidance for a media data transmission link of the present embodiment is provided.

In conjunction with the above-mentioned embodiments, taking the first edge node and the second edge node as an example, the first edge node and the second edge node are cascaded and connected, and then link probing is performed; if the communication quality is good, the link detection can be continued, and if the communication quality is poor, the link is replaced and the connection is re-established, and the first edge node tries to connect with other edge nodes; if the retry succeeds, returning to the step of link detection; if the retry fails, judging whether the number of consecutive failure is greater than 3 times, if not, returning to the step of replacing the link and retrying to establish the connection, and if yes, determining an interval threshold T for Node Change according to the current number of Node Change (for example, T=5 seconds between the 2nd and 1st Node Change, T=7 seconds between the 3rd and 2nd Node Change, and T=10 seconds between the 4th subsequent and previous Node Change). The interval threshold T increases as the number of Node Change increases, and if the interval from the last Node Change is greater than T, the user is then removed from the first edge node and a user reconnect is performed to switch the client to other edge nodes.

There is also provided in the present embodiment a media data transmission link optimization apparatus for implementing the above-mentioned embodiments and preferred embodiments, and the depiction thereof would not be repeated. As used below, the term “module” may implement a combination of software and/or hardware for a preset function. Although the apparatus described in the following embodiments is preferably implemented in software, implementations in hardware, or a combination of software and hardware, are also possible and contemplated.

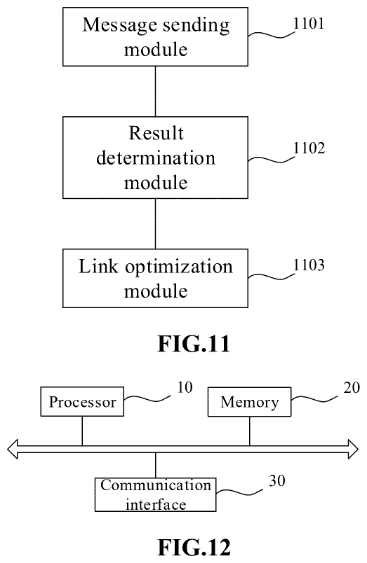

The present embodiment provides a media data transmission link optimization device, as shown in FIG. 11, comprising:

A message sending module 1101, used for sending a report message to a second edge node, wherein the second edge node is a next hop node successfully establishing a connection with the first edge node.

A result determination module 1102, used for determining a message loss result and a round-trip time result according to an acknowledgement message replied by the second edge node based on the report message, wherein the message loss result is used for characterizing a situation that the report message is lost, and the round-trip time result is used for characterizing transmission delay between the first edge node and the second edge node.

A link optimization module 1103 for optimizing a media data transmission link including the first edge node according to the message loss result and the round-trip time result.

In some alternative embodiments, the message loss result comprises a number of message loss and the round-trip time result comprises an average round-trip time.

The link optimization module 1103 is specifically used for disconnecting the connection between the first edge node and the second edge node and replacing the next hop node of the first edge node with the third edge node according to the number of message loss being greater than the first preset number and the average round-trip time being greater than the first preset duration.

In some alternative embodiments, the link optimization module 1103 is specifically used for notifying the scheduling node to add the second edge node into the preset list according to the number of message loss being greater than the second preset number and the average round-trip time being greater than the second preset duration; the edge node recorded in the preset list is used for representing a node avoided by the scheduling node when performing transmission link planning; the second preset number is less than the first preset number, and the second preset duration is less than the first preset duration.

In some alternative embodiments, the result determination module 1102 includes a statistical unit and a determination unit.

The statistics unit is used for counting a total number of acknowledgement messages replied by the second edge node based on a specified number of report messages, and determining a plurality of round-trip times based on the specified number of report messages.

The determination unit is used for determining a difference value between the specified number and the total number of the acknowledgement messages as a number of the message loss, and determining an average of a plurality of round-trip times as the average round-trip time.

In some alternative embodiments, the link optimization module 1103 includes a path acquisition unit, a retry operation unit, and a node replacement unit.

The path acquisition unit for obtaining at least one new path based on the scheduling service provided by the scheduling node, the at least one new path comprising a path from the first edge node to the source station via the third edge node.

The retry operation unit is used for performing the retry operation to try to establish the connection between the first edge node and the third edge node.

A node replacement unit for replacing the next hop node of the first edge node with the third edge node upon successful retry.

In some alternative embodiments, the link optimization module 1103 may also include a retry unit and a node removal unit.

The retry unit is used for retrying again upon failed retey to try to establish the connection between the first edge node and the fourth edge node.

The client removal unit is used for removing the client from the first edge node according to the number of consecutive failed retry exceeding the first preset number of times, and switching the edge node providing a media data service for the client from the first edge node to the fifth edge node.

In some alternative embodiments, the media data transmission link optimization apparatus further comprises a serving node switching module and a time interval increasing module.

The serving node switching module is used for, according to the number of times of connection failure between the plurality of first edge nodes and respective upstream nodes exceeds the second preset number of times, moving all the plurality of clients in the plurality of first edge nodes, and switching an edge node providing the media data service for the plurality of clients from the plurality of first edge nodes to the sixth edge node; a plurality of clients are all clients joining the target room, and a plurality of first edge nodes provide the media data service for the clients in the target room, and the upstream node comprises at least one of the source station, the relay node and an upstream edge node.

The time interval increasing module is used for controlling the time interval of two adjacent move-out actions to gradually increase for the target room according to the number of times the client is moved out from the edge node being at least two times.

In some alternative embodiments, the media data transmission link optimization apparatus further comprises a failure determination module and a heartbeat broadcast module.

The failure determination module is used for determining that the source station is unreachable according to that the heartbeat information sent by the source station is not received within the third preset duration.

The heartbeat broadcast module is used for broadcasting the heartbeat information to the downstream node according to the heartbeat information sent by the source station received within the third preset duration, and the downstream node comprises at least one of the downstream edge node and the relay node.

In some alternative embodiments, the failure determination module is further configured to disconnect the connection between the first edge node and the second edge node upon determining that the source station is unreachable, and performing the timed retry after waiting for the fourth preset duration to establish the connection between the first edge node and the source station.

Further functional descriptions of the respective modules and the respective units described above are identical to the corresponding embodiments described above and would not be repeated here.

The media data transmission link optimization apparatus according to the present embodiment is presented in the form of a functional unit, and the unit refers to an ASIC (Application Specific Integrated Circuit) circuit, a processor and a memory executing one or more software or fixed programs, and/or other devices which can provide the above-mentioned functions.

Embodiments of the present disclosure also provide a computer device having the media data transmission link optimization apparatus for described above and illustrated in FIG. 11.

With reference to FIG. 12, FIG. 12 illustrates a schematic diagram of a computer device according to an embodiment of the present disclosure. As shown in FIG. 12, the computer device comprises: one or more processors 10, A memory 20, and interfaces for connecting components, and the interfaces include high speed interfaces and low speed interfaces. The various components are communicatively coupled to each other using different buses and may be mounted on a common motherboard or otherwise as desired. The processor may process instructions executed within the computer device, including instructions stored in the memory or on the memory to display graphical information of the GUI on an external input/output device, such as a display device coupled to the interface. In some alternative embodiments, multiple processors and/or multiple buses may be used with multiple memories and multiple memories, if desired. Also, multiple computer devices may be connected, each providing some of the necessary operations (e.g. as a server array, a set of blade servers, or a multi-processor system). An example of the processor 10 is shown in FIG. 12.

The processor 10 may be a central processor, a network processor, or a combination thereof. Among other things, the processor 10 may further include a hardware chip. The hardware chips may be application specific integrated circuits, programmable logic devices, or a combination thereof. The programmable logic device may be a complex programmable logic device, a field programmable gate array, general purpose array logic, or any combination thereof.

The memory 20 stores therein instructions executable by at least one processor 10 to cause the at least one processor 10 to perform a method embodying the embodiments shown above.

The memory 20 may comprise a program storage area and a data storage area, wherein the program storage area may store an operating system and an application program required by at least one function; the storage data area may store data or the like created according to the use of the computer device. In addition, memory 20 may include high speed random access memory and may also include non-transitory memory such as at least one magnetic disk storage device, flash memory device, or other non-transitory solid state storage device. In some alternative embodiments, memory 20 may optionally include memory remotely located with respect to processor 10, which may be connected to the computer device via a network. Examples of such networks include, but are not limited to, the Internet, intranets, local area networks, mobile communication networks, and combinations thereof.

The memory 20 may include volatile memory, e.g. random access memory; the memory may also comprise a non-volatile memory, for example, a flash memory, a hard disk or a solid-state hard disk; the memory 20 may also comprise a combination of memories of the kind described above.

The computer device further comprises a communication interface 30 for the computer device to communicate with other devices or communication networks.

Embodiments of the present disclosure also provide a computer-readable storage medium in which the above-described methods according to embodiments of the present disclosure may be implemented in hardware, firmware, or as computer code that may be recorded on a storage medium, or downloaded over a network, originally stored on a remote storage medium or a non-transitory machine-readable storage medium to be stored on a local storage medium, such that the methods described herein may be processed by such software stored on a storage medium using a general purpose computer, a dedicated processor, or programmable or dedicated hardware. Wherein the storage medium can be a magnetic disk, an optical disk, a read-only storage memory, a random storage memory, a flash memory, a hard disk or a solid-state hard disk, etc.; further, the storage medium may also comprise a combination of memories of the kind described above. It will be appreciated that a computer, processor, microprocessor controller or programmable hardware includes a storage component that can store or receive software or computer code that, when accessed and executed by a computer, processor or hardware, performs the methods illustrated by the embodiments described above.

Although the embodiments of the present disclosure have been described in conjunction with the accompanying drawings, those skilled in the art can make various modifications and variations without departing from the spirit and scope of the present disclosure, and such modifications and variations fall within the scope of the appended claims.

I/We claim:

1. A media data transmission link optimization method being applied to a first edge node, the method comprising:
sending a report message to a second edge node that is a next hop node successfully connected with the first edge node;
determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node; and
optimizing a media data transmission link including the first edge node according to the message loss result and the round-trip time result.

2. The method according to claim 1, wherein the message loss result comprises an amount of message lost, and the round-trip time result comprises an average round-trip time, and optimizing the media data transmission link comprising the first edge node according to the message loss result and the round-trip time result comprises:
in response to the amount of message lost being greater than a first preset number and the average round-trip time being greater than a first preset duration, disconnecting a connection between the first edge node and the second edge node, and replacing a next hop node of the first edge node with a third edge node.

3. The method according to claim 2, wherein optimizing the media data transmission link comprising the first edge node according to the message loss result and the round-trip time result comprises:
in response to the amount of message lost being greater than a second preset number and the average round-trip time being greater than a second preset duration, notifying a scheduling node to add the second edge node into a preset list, wherein an edge node recorded within the preset list is used for representing a node avoided by the scheduling node when performing transmission link planning; and
wherein the second preset number is less than the first preset number, and the second preset duration is less than the first preset duration.

4. The method according to claim 2, wherein determining the message loss result and the round-trip time result according to the acknowledgement message replied by the second edge node based on the report message comprises:
counting a total number of acknowledgement messages replied by the second edge node based on a specified number of the report messages, and determining a plurality of round-trip times based on the specified number of the report messages; and
determining a difference value between the specified number and the total number of the acknowledgement messages as the amount of message lost, and determining an average value of the plurality of round-trip times as the average round-trip time.

5. The method of claim 2, wherein replacing the next hop node of the first edge node with the third edge node comprises:
obtaining at least one new path based on a scheduling service provided by a scheduling node, wherein the at least one new path comprises a path from the first edge node to a source station via the third edge node;
performing a retry operation to attempt to establish a connection between the first edge node and the third edge node; and
replacing the next hop node of the first edge node with the third edge node upon successful retry.

6. The method of claim 5, wherein the method further comprises:
retrying again to try to establish a connection between the first edge node and a fourth edge node upon failed retry; and
in response to a number of consecutive failed retry exceeding a first preset number, removing a client from the first edge node and switching an edge node providing a media data service for a client from the first edge node to a fifth edge node.

7. The method of claim 1, wherein the method further comprises:
in response to a number of times of connection failure between a plurality of the first edge nodes and respective upstream nodes exceeding a second preset number of times, removing all the plurality of clients in the plurality of first edge nodes, and switching an edge node providing a media data service for the plurality of clients from the plurality of the first edge nodes to a sixth edge node, wherein the plurality of clients are all clients joining a target room, the plurality of the first edge nodes all provide a media data service for clients in the target room, and the upstream node comprises at least one of a source station, a relay node and an upstream edge node; and
for the target room, in response to the number of times the client being removed from the edge node being at least two times, controlling a time interval between two adjacent move-out actions to gradually increase.

8. The method of claim 1, wherein the method further comprises:
in response to heartbeat information sent by a source station being not received within a third preset duration, determining the source station to be unreachable; and
in response to the heartbeat information sent by the source station being received within the third preset duration, broadcasting the heartbeat information to downstream nodes, wherein the downstream nodes comprise at least one of a downstream edge node and a relay node.

9. The method of claim 8, wherein the method further comprises:
in response to determining the source station to be unreachable, disconnecting a connection between the first edge node and the second edge node, and performing a timed retry after waiting for a fourth preset duration to try to establish a connection between the first edge node and the source station.

10. A computer device comprising:
a memory and a processor communicatively coupled to each other, wherein the memory has computer instructions stored therein, and the processor executes the computer instructions to perform a media data transmission link optimization method comprising:
sending a report message to a second edge node that is a next hop node successfully connected with the first edge node;
determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node; and
optimizing a media data transmission link including the first edge node according to the message loss result and the round-trip time result.

11. The computer device according to claim 10, wherein the message loss result comprises an amount of message lost, and the round-trip time result comprises an average round-trip time, and optimizing the media data transmission link comprising the first edge node according to the message loss result and the round-trip time result comprises:
in response to the amount of message lost being greater than a first preset number and the average round-trip time being greater than a first preset duration, disconnecting a connection between the first edge node and the second edge node, and replacing a next hop node of the first edge node with a third edge node.

12. The computer device according to claim 11, wherein optimizing the media data transmission link comprising the first edge node according to the message loss result and the round-trip time result comprises:
in response to the amount of message lost being greater than a second preset number and the average round-trip time being greater than a second preset duration, notifying a scheduling node to add the second edge node into a preset list, wherein an edge node recorded within the preset list is used for representing a node avoided by the scheduling node when performing transmission link planning; and
wherein the second preset number is less than the first preset number, and the second preset duration is less than the first preset duration.

13. The computer device according to claim 11, wherein determining the message loss result and the round-trip time result according to the acknowledgement message replied by the second edge node based on the report message comprises:
counting a total number of acknowledgement messages replied by the second edge node based on a specified number of the report messages, and determining a plurality of round-trip times based on the specified number of the report messages; and
determining a difference value between the specified number and the total number of the acknowledgement messages as the amount of message lost, and determining an average value of the plurality of round-trip times as the average round-trip time.

14. The computer device of claim 11, wherein replacing the next hop node of the first edge node with the third edge node comprises:
obtaining at least one new path based on a scheduling service provided by a scheduling node, wherein the at least one new path comprises a path from the first edge node to a source station via the third edge node;
performing a retry operation to attempt to establish a connection between the first edge node and the third edge node; and
replacing the next hop node of the first edge node with the third edge node upon successful retry.

15. The computer device of claim 14, wherein the method further comprises:
retrying again to try to establish a connection between the first edge node and a fourth edge node upon failed retry; and
in response to a number of consecutive failed retry exceeding a first preset number, removing a client from the first edge node and switching an edge node providing a media data service for a client from the first edge node to a fifth edge node.

16. The computer device of claim 10, wherein the method further comprises:
in response to a number of times of connection failure between a plurality of the first edge nodes and respective upstream nodes exceeding a second preset number of times, removing all the plurality of clients in the plurality of first edge nodes, and switching an edge node providing a media data service for the plurality of clients from the plurality of the first edge nodes to a sixth edge node, wherein the plurality of clients are all clients joining a target room, the plurality of the first edge nodes all provide a media data service for clients in the target room, and the upstream node comprises at least one of a source station, a relay node and an upstream edge node; and
for the target room, in response to the number of times the client being removed from the edge node being at least two times, controlling a time interval between two adjacent move-out actions to gradually increase.

17. The computer device of claim 10, wherein the method further comprises:
in response to heartbeat information sent by a source station being not received within a third preset duration, determining the source station to be unreachable; and
in response to the heartbeat information sent by the source station being received within the third preset duration, broadcasting the heartbeat information to downstream nodes, wherein the downstream nodes comprise at least one of a downstream edge node and a relay node.

18. The computer device of claim 17, wherein the method further comprises:
in response to determining the source station to be unreachable, disconnecting a connection between the first edge node and the second edge node, and performing a timed retry after waiting for a fourth preset duration to try to establish a connection between the first edge node and the source station.

19. A non-transitory computer-readable storage medium having stored thereon computer instructions for causing a computer to perform a media data transmission link optimization method comprising:
sending a report message to a second edge node that is a next hop node successfully connected with the first edge node;
determining a message loss result and a round-trip time result according to an acknowledgement message replied by the second edge node based on the report message, wherein the message loss result is used for characterizing a situation that the report message is lost, and the round-trip time result is used for characterizing a transmission delay between the first edge node and the second edge node; and
optimizing a media data transmission link including the first edge node according to the message loss result and the round-trip time result.

20. The non-transitory storage medium of claim 19, wherein the message loss result comprises an amount of message lost, and the round-trip time result comprises an average round-trip time, and optimizing the media data transmission link comprising the first edge node according to the message loss result and the round-trip time result comprises:
in response to the amount of message lost being greater than a first preset number and the average round-trip time being greater than a first preset duration, disconnecting a connection between the first edge node and the second edge node, and replacing a next hop node of the first edge node with a third edge node.
